(19) United States
(12) Patent Application Publication
(10) Pub. No.: US 2016/0162680 A1
(43) Pub. Date: Jun. 9, 2016

(54) Login System And Method With Integrated Password And Verification Code

(71) Applicants: Inventec (Pudong) Technology Corporation, Shanghai (CN); Inventec Corporation, Taipei City (TW)

(72) Inventor: Long Chen, Shanghai (CN)

(21) Appl. No.: 14/662,772

(22) Filed: Mar. 19, 2015

(30) Foreign Application Priority Data
Dec. 4, 2014 (CN) 201410729216.1

(51) Int. Cl. G06F 21/40

(52) U.S. Cl. CPC G06F 21/40

(57) ABSTRACT

A login system and method with an integrated password and verification code are provided, in which an input frame and verification code are displayed on a login interface having a user message and the password and the verification code are prompted to be simultaneously keyed into the input frame, so that a key-in message may be decomposed into a password message and a verification message for a login verification use, whereby achieving the technical efficacy of an enhanced convenience of the login operation onto the login interface of a mobile device.

### CROSS-REFERENCE TO RELATED APPLICATION

This application claims the benefit of Chinese Patent Application No. 201410729216.1, filed Dec. 4, 2014.

### BACKGROUND OF THE RELATED ART

1. Technical Field

The present invention relates to a login system and method, and particularly to a login system and method on which a password and a verification code forming an integrated password and verification code are keyed into a same input frame simultaneously.

2. Related Art

For recent years, various login interfaces used on mobile devices have been widely developed with prevalence of the mobile devices.

Generally, owing to the limitation of the display screen and operation manner of the mobile devices, a login interface is typically optimally designed to adapt to the touch operations applied onto the mobile device. However, the optimal design still leaves something to be considered. For example, in addition to an input frame for a password inputted therein, a verification code is generally requested for the user to be keyed into anther input frame on the login interface, for an exemption from a password cracking event. On a conventional login interface, the password and verification code may be conveniently keyed in by clicking the key “Tab” on a physical keyboard for switching over different input frames. However, the mobile device usually employs a software keyboard, so it has to close the software keyboard before keying in the verification code after the password is keyed in, so that the input frame may be touched for the verification code's input and the subsequent input. In other words, it is inconvenient to switch over different input frames for operation on a mobile device. This inconvenience issue of login on the login interface of the mobile device.

In response, there is a technology for replacement of the verification key-in by using a sliding operation axis proposed. In this technology, an operation axis corresponding to a distorted pattern is displayed previously. The distorted pattern is adjusted when the operation axis slides. If the distorted pattern becomes a normal pattern, the verification is passed, otherwise not passed. However, this manner causes a trouble to those poorly recognizing patterns and the operation axis may only slide after the software keyboard is closed. Therefore, the above issue of the inconvenient login operation on the login interface of the mobile device still has to be overcome.

In view of the above, it may be known that there has long been the issue of the inconvenient login operation on the login interface of the mobile device. Therefore, there is quite a need to set forth an improvement means to settle down this problem.

### SUMMARY

It is, therefore, an object of the present invention to provide a login system and method with an integrated password and verification code integrated applied on a login interface.

According to the present invention, the login system with an integrated password and verification code applied on a login interface comprises a display module, displaying an input frame and the verification code on the login interface having a user message, and prompting a user to key in the password and the verification code within the input frame simultaneously; an input module, receiving a key-in message from the input frame; a decomposition module, decomposing the key-in message into a password message and a verification code according to a preset decomposition condition; and a verification module, querying a user database according to the user message and the password message to obtain a query result when the password message and the verification code match with each other, and allowing the user to log in when the query result shows a consistency.

According to the present invention, the login method with the verification code and the password integrated applied on the login interface, comprising steps of displaying an input frame and the verification code on the login interface having a user message, and prompting a user to key in the password and the verification code within the input frame simultaneously; receiving a key-in message from the input frame; decomposing the key-in message into a password message and a verification code according to a preset decomposition condition; and querying a user database according to the user message and the password message to obtain a query result when the password message and the verification code match with each other, and allowing the user to log in when the query result shows a consistency.

The system and method of the present invention has the difference as compared to the prior art that the input frame and verification code are displayed on the login interface having the user message and the password and the verification code are prompted to be simultaneously keyed into the input frame, so that the key-in message may be decomposed into the password message and the verification message for a login verification use.

By using the above technical means, the present invention may achieve the technical efficacy of an enhanced convenience of the login operation onto the login interface of a mobile device.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a systematic block diagram of a login system for an integrated password and verification code according to the present invention;

FIG. 2 is a flowchart of a login method for the integrated password and verification code according to the present invention;

FIG. 3 is a schematic diagram of a login operation using the present invention;

FIG. 4 is a schematic diagram of decomposing a key-in message using the present invention; and

FIG. 5 is a schematic diagram of the login operation of another embodiment using the present invention.

### DETAILED DESCRIPTION

The present invention will be apparent from the following detailed description, which proceeds with reference to the accompanying drawings, wherein the same references relate to the same elements.

Prior to the description of the login system and method on which a password and a verification code forming an integrated password and verification code are keyed into a same input frame simultaneously according to the present invention, the environment the present invention is applied onto is first described. The present invention is applied onto a login interface, which may be a webpage to be browsed on a mobile device. Since the mobile device has the limited features of no physical keyboard and a smaller display frame, a graphical user interface (GUI) and a webpage design of the GUI on the mobile device are both different from the conventional webpage, and may be optimal to any touch operation.

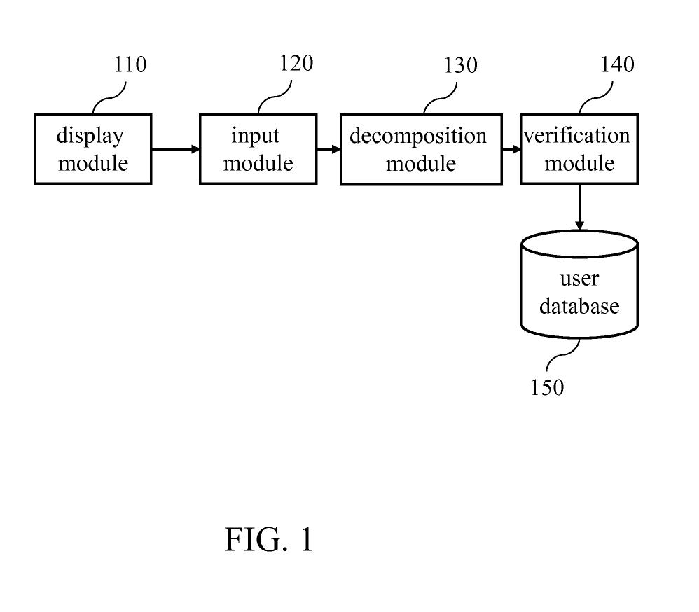

In the following, the login system and method on which the verification code and the password are integrated will be described in details. Referring to FIG. 1, a systematic block diagram of a login system for an integrated password and verification code according to the present invention is shown therein, which is applied onto a login interface. The system comprises a display module 110, which displays an input frame and the verification code on a login interface having a user message and prompts to key in the password and the verification code in this input frame. In real implementation, the user message is an account or a card number having a singularity, and even an email may be served as the account.

The input module 120 is used to receive a key-in message from the input frame. In real implementation, after a user touches the input frame, the mobile device may display a software keyboard for the user to key in a content. And, after an ascertain key is touched, the input module 120 may take characters keyed by the user into the input frame as a key-in message. The reception of the key-in message by the input frame belongs to the prior art, and thus omitted herein for clarity.

The decomposition module 130 is used to decompose the key-in message into the password message and the verification message according to a preset decomposition condition. In real implementation, the verification code is a predetermined length (may be known after the verification code). At this time, the decomposition condition may key the message by referring to the known length. For example, assume the known length is five characters, the decomposition module 130 may decompose the first three characters to serve them as a password message and the last five characters as the verification message when the key-in message is eight characters. In addition, the decomposition condition may also decompose the key-in message according to the preset decomposition characters, wherein the decomposition characters are a text, number, null characters or symbol. For example, assume the decomposition characters are preset as the symbol “+”. When the key-in message is “password+abcd”, the decomposition module 130 may serve all the characters post to the decomposition characters, i.e. “abcd” as the verification message.

The verification module 140 is used to query the user database by using the user message and the password message when the verification message matches with the verification code. When the query result shows a consistency, the user is allowed to log in. The user database has the preset account and password by the user stored therein, and which are used for comparison with the user message and the password message. Since the verification code is set forth for an exemption from a crack or an automatic operation made by a robot automation. Therefore, the verification code is first determined as being correct or not, in the real implementation, and then used to query the user database, exempting from an additionally increased load of the user database.

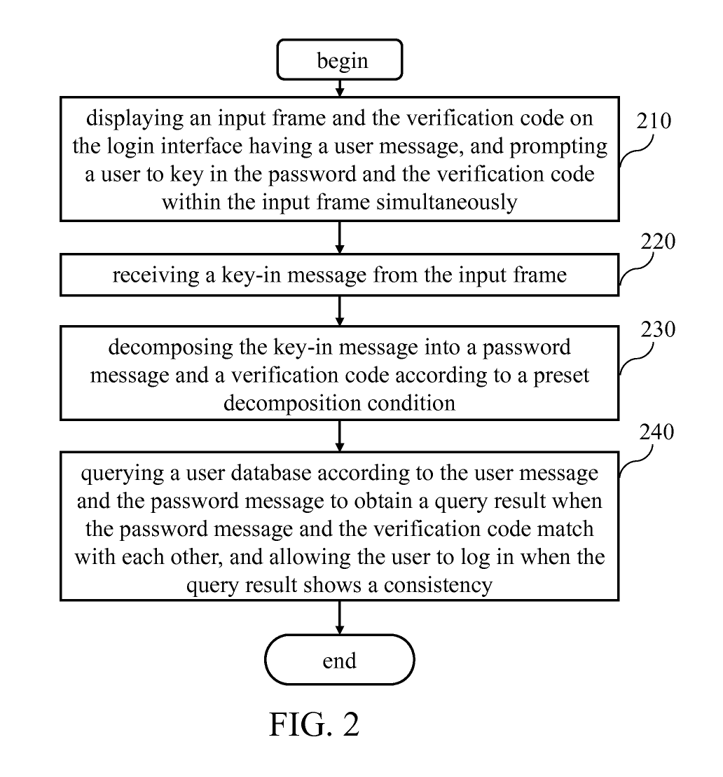

Thereafter, referring to FIG. 2, flowchart of a login method for the integrated password and verification code according to the present invention is shown therein, and which is applied onto the login interface. The method comprises the following steps. At first, an input frame and the verification code are first displayed on the login interface having the user message, and the user is first prompted to key in the password and the verification code within the input frame simultaneously (Step 210). Next, a key-in message is received from the input frame (Step 220). Then, the key-in message is decomposed into the password message and the verification code according to the preset decomposition condition (Step 230). Thereafter, the user database according to the user message and the password message to obtain a query result when the password message and the verification code match with each other, and allowing the user to log in when the query result shows a consistency (Step 240). Based on the above steps, the input frame and verification code are displayed on the login interface having the user message and the password and the verification code are prompted to be simultaneously keyed into the input frame, so that the key-in message may be decomposed into the password message and the verification message for a login verification use.

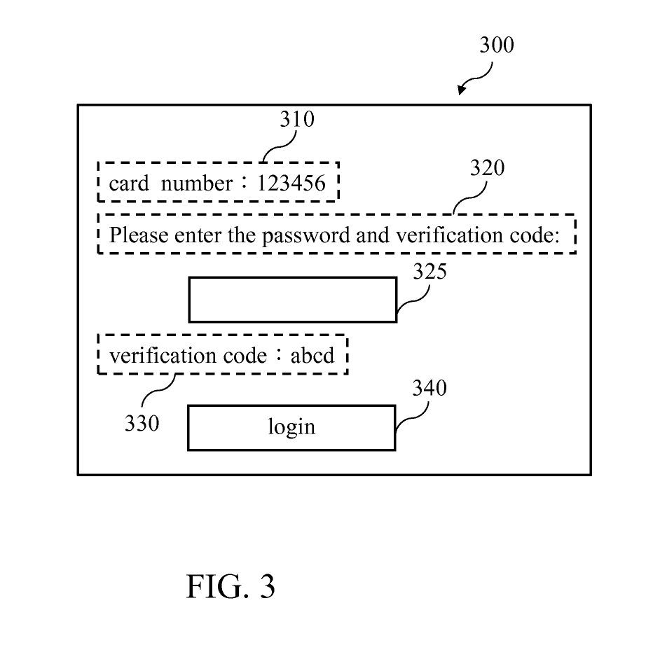

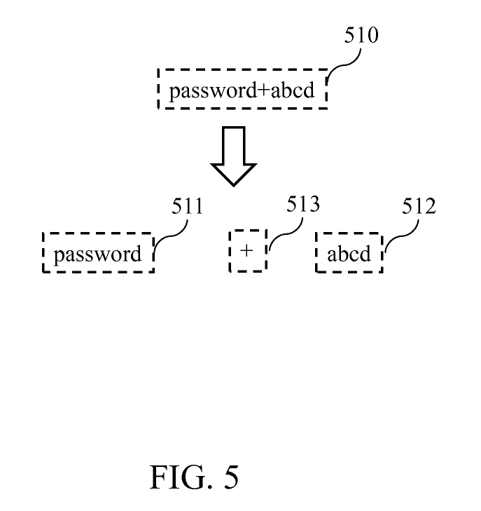

In the following, the FIG. 3 and FIG. 5 are set forth to illustrate the present invention in a form of an embodiment. At first, referring to FIG. 3, a schematic diagram of a login operation using the present invention is shown therein. When a login operation is performed on the login interface, the login interface 300 may display the user message 310, the prompt message 320, the input frame 325, the verification code message 330 (including the verification code), and a login component 340. The user message 310 may be a credit card number, a membership number, a serial number, and any number having a singularity sense of information for recognizing an identification of the user. After the user touches the input frame 325, the mobile device may display the software keyboard for an input by the user. At this time, the software keyboard will be displayed by and on the mobile device for an input by the user after the user touches the input frame 325. Furthermore, the user may key in the password according to the password having been keyed into the input frame 325, and may key in the verification code at the same input frame according to the verification code displayed. Finally, after the user touches the login component 340, the input module 120 may receive the password and verification code sequentially keyed in the same input frame 325 by the user as the key-in message and decompose the key-in message into the password message and the verification message according to the preset decomposition condition, so that if the user may be allowed to reach the login state by querying the user database by referring to the user message and the password message, when the verification message and the verification code is consistency.

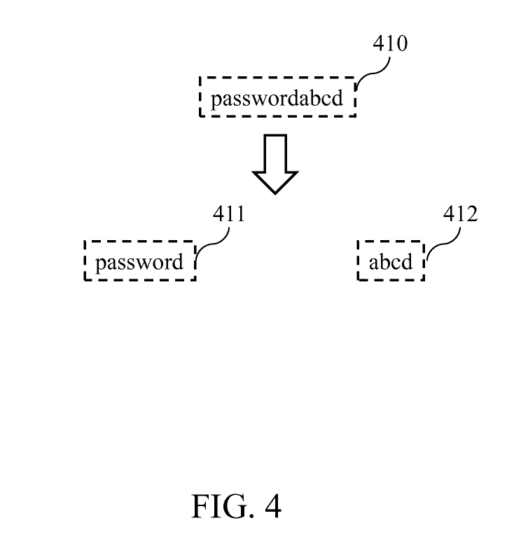

As shown in FIG. 4, a schematic diagram of decomposing a key-in message using the present invention is illustrated. As mentioned above, the input module 120 may receive the key-in message sequentially keyed in the input frame 325 by the user, and then decompose the key-in message into the password message and the verification message according to the preset condition. Assume the key-in message 410 is “passwordabcd”, the preset decomposition message has five characters, and then the decomposition module 130 will decompose the password message 411 and the verification message 412 according to the preset decomposition condition as shown in FIG. 4. It is to be particularly pointed out that the user may be allowed to input the verification code again to update the verification message if the verification code keyed in by the user is determined as mismatching with the verification message 412. Likewise, after the user database is allowed to be queried by using the user message 310 and the password message, the user is also allowed to key in his password again to update the password message 411 if the query result is shown as inconsistency, and then the user message 310 and the updated password message may be relied up to query the user database 150.

As shown in FIG. 5, which a schematic diagram of the login operation of another embodiment using the present invention. In real implementation, in addition to the continuous input of the password and the verification code at the input frame 325, a decomposition character 513 may be introduced into among the password and the verification code, such as the symbol “+”. At this time, the key-in message 510 is “password+abcd”, the decomposition module 130 may decompose all the characters prior to the decomposition character 513 into the password message 511, and all the characters post to the decomposition character 513 into the verification code message 512.

In summary, the system and method of the present invention has the difference as compared to the prior art that the input frame and verification code are displayed on the login interface having the user message and the password and the verification code are prompted to be simultaneously keyed into the input frame, so that the key-in message may be decomposed into the password message and the verification message for a login verification use. By using the above technical means, the present invention may well solve the issue encountered in the prior art and achieve the technical efficacy of an enhanced convenience of login operation onto the login interface of a mobile device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A login system with an integrated password and verification code applied on a login interface, comprising:
a display module, displaying an input frame and the verification code on the login interface having a user message, and prompting a user to key in the password and the verification code within the input frame simultaneously;
an input module, receiving a key-in message from the input frame;
a decomposition module, decomposing the key-in message into a password message and a verification code according to a preset decomposition condition; and
a verification module, querying a user database according to the user message and the password message to obtain a query result when the password message and the verification code match with each other, and allowing the user to log in when the query result shows a consistency.

2. The login system with the verification code and the password integrated applied on the login interface as claimed in claim 1, wherein the user message is an account or a card number having a singularity.

3. The login system with the verification code and the password integrated applied on the login interface as claimed in claim 1, wherein the verification code has a known length, and the decomposition condition is decomposing the key-in message according to the known length.

4. The login system with the verification code and the password integrated applied on the login interface as claimed in claim 1, wherein the decomposition condition is decomposing the key-in message according to a preset decomposition character, wherein the decomposition character is selected from a group consisting of a text, a number, a null character or a symbol.

5. The login system with the verification code and the password integrated applied on the login interface as claimed in claim 1, wherein the client data stores a preset account and password for comparing with the user message and the password message.

6. A login method with an integrated password and verification code applied on a login interface, comprising steps of:
displaying an input frame and the verification code on the login interface having a user message, and prompting a user to key in the password and the verification code within the input frame simultaneously;
receiving a key-in message from the input frame;
decomposing the key-in message into a password message and a verification code according to a preset decomposition condition; and
querying a user database according to the user message and the password message to obtain a query result when the password message and the verification code match with each other, and allowing the user to log in when the query result shows a consistency.

7. The login method with the verification code and the password integrated applied on the login interface as claimed in claim 6, wherein the user message is an account or a card number having a singularity.

8. The login method with the verification code and the password integrated applied on the login interface as claimed in claim 6, wherein the verification code has a known length, and the decomposition condition is decomposing the key-in message according to the known length.

9. The login method with the verification code and the password integrated applied on the login interface as claimed in claim 6, wherein the decomposition condition is decomposing the key-in message according to a preset decomposition character, wherein the decomposition character is selected from a group consisting of a text, a number, a null character or a symbol.

10. The login method with the verification code and the password integrated applied on the login interface as claimed in claim 6, wherein the client data stores a preset account and password for comparing with the user message and the password message.
